(19) United States
(12) Patent Application Publication
(10) Pub. No.: US 2005/0161956 A1
(43) Pub. Date: Jul. 28, 2005

(54) Systems and methods for holding together first and second objects

(76) Inventor: Michael W. Hicok, Olney, MD (US)

Correspondence Address: Donald A. Kettlestrings, Suite 211, 414 Hungerford Drive, Rockville, MD, 20850, US

(21) Appl. No.: 11/049,156

(22) Filed: Feb. 2, 2005

Related U.S. Application Data
(63) Continuation-in-part of application No. 10/762,774, filed on Jan. 23, 2004.
(60) Provisional application No. 60/547,473, filed on Feb. 26, 2004.

(51) Int. Cl. G06F 13/36

(52) U.S. Cl. 292/240

(57) ABSTRACT

Systems and methods for holding together first and second objects include a first support connected to and projecting from the first object wherein the first support defines at least an opening therein. The second object is positioned adjacent to the first object, to the first support and to the first opening. A fastening member is movably positioned within the opening and is positioned with respect to the second object for selectively holding the second object in fixed position with respect to the first object.

### CROSS-REFERENCE TO RELATED APPLICATIONS

This application is a continuation-in-part of prior application No. 10/762,774, filed Jan. 23, 2004, and this application claims the benefit of U.S. provisional application No. 60/547,473, filed Feb. 26, 2004.

### BACKGROUND OF THE INVENTION

This invention relates to fastening systems and methods and more particularly to systems and methods for holding together first and second objects.

Current systems for connecting covers to electrical panelboards and other electrical cabinets, for example, do not allow for quick and safe removal and installation of panelboard and enclosure covers. Current systems use screws, clamps, clips and brackets to hold covers to the panelboard back box.

In many of these current systems, connecting devices are installed in the wire or electrical section of the panelboard enclosure. Having these devices in the electrical section of the cabinet or enclosure creates a potential for the devices to come into contact with ungrounded, live conductors and other elements within the enclosure possibly causing electrical explosions, ground faults, or arcing which can be potentially hazardous to personnel and the equipment. Many accidents have occurred because of this design flaw. The designs of electrical panelboard and other electrical equipment cabinet covers seem to be afterthoughts because they do not self-align nor do they connect very well with the panelboards or cabinets.

The systems and methods of this invention provide a quick and secure way to attach and remove all types of electrical panelboards and electrical equipment covers. The systems of this invention can be designed to be incorporated on any type of new equipment as well as retrofitted to existing equipment.

Once a system of this invention is installed, all components that hold the equipment covers in place are external to the equipment and, therefore, eliminate the potential for hazardous conditions. Once installed, the systems provide a quick and easy way to remove and replace electrical equipment covers because the systems are self-aligning, support the cover and provide a low-resistance ground path.

With the systems and methods of this invention, the equipment cover will always go on and come off easily no matter how many times the equipment cover is removed and replaced. The systems have few parts to wear out, and the systems are cost effective because they use parts that can be easily obtained, are inexpensive to manufacture, are easy to install and are very durable. The systems and methods of this invention provide a strong ledge or support upon which to set the cover in place before it is connected to the panelboard box or cabinet, and the ledge or support in cooperation with brackets provides exact alignment of the panel cover with respect to the cabinet. Most manufacturers of electrical panels have an inner trim panel cover that is attached to the panel prior to installation of the outer cover. The alignment provided by the systems and methods of this invention will allow manufacturers of equipment to attach the inner trim cover directly to the outer panel cover or will allow the manufacturers to build them as one piece and therefore simplify the panel design.

Although the systems and methods of this invention are described herein specifically with reference to the connection of covers to electrical cabinets, it should be understood that the systems and methods of this invention are applicable to many other situations where it is desired to firmly hold together first and second objects.

The components from each system described herein are designed to work independently or can be mixed or matched separately and used with other components to provide panel and system cover connections for every application. The systems described herein are compatible with and provide connections of all manufacturers' equipment covers to enclosures or equipment. All systems described herein can be installed and removed using simple tools. The systems described herein allow fast, simple and safe removal and replacement of any type equipment cover.

It is, therefore, an object of the present invention to provide systems and methods for holding together first and second objects.

Another object is to provide such systems and methods which use an eccentric fastening member in cooperation with a first support whereby rotation of the fastening member within the support acts to forcibly hold the second object in fixed position with respect to the first object.

A further object of the invention is the provision of such systems and methods which are particularly useful for connecting covers to electrical cabinets in a quick and safe manner.

Still another object is to provide such systems and methods which can be used to connect together many different types of first and second objects.

Additional objects and advantages of the invention will be set forth in part in the description which follows, and in part will be obvious from the description, or may be learned by practice of the invention. The objects and advantages are realized and attained by means of the instrumentalities and combinations particularly pointed out in the appended claims.

To achieve these and other objects, the present invention provides a system for holding together first and second objects, the system comprising: a first support connected to and projecting from the first object, the first support defining at least a first opening therein; the second object positioned adjacent to the first object, to the first support and to the first opening; a first fastening member positioned in the first opening and defining a second, threaded opening therein; and a second fastening member threadably positioned within the second threaded opening and positioned with respect to the second object for enabling the second fastening member to selectively hold the second object in fixed position with respect to the first object as the second fastening member is rotated within the second threaded opening.

To further achieve these and other objects, the present invention provides an assembly for holding together first and second objects, the assembly comprising: a first support for connecting to the first object and having first and second axially aligned and spaced-apart, hollow, substantially cylindrical members; the first support further having a first member connected to the cylindrical members for connecting to the first object; a shaft defining first and second ends and movably positioned within the cylindrical members with the first end extending outwardly beyond the first cylindrical member; a stop member connected to the shaft, positioned between the first and second cylindrical members and extending outwardly from the shaft beyond the cylindrical members for selectively contacting the first member and for enabling substantially 180° rotational movement of said shaft within the cylindrical members; a second member connected to the first end of the shaft, the second member defining a threaded opening therein; and a threaded member threadably engaging the threaded opening for selectively holding the second object in fixed position with respect to the first object.

To further achieve these and other objects, the present invention provides for use in a system having at least two abutting open-front boxes having first and second flanges, respectively, extending into the open fronts substantially around the perimeters of the open fronts and having first and second covers, respectively, sized to substantially cover the open fronts, the improvement comprising: a first substantially T-shaped support connected to and projecting outwardly from the first and second flanges; the T-shaped support having a projecting member positioned substantially perpendicularly with respect to the first and second flanges; the projecting member defining first and second openings therein; first and second fastening members positioned within the first and second openings, respectively; and the covers respectively positioned over the open fronts and between the T-shaped support and the fastening members, whereby the fastening members hold the covers in fixed positions over the open fronts.

To further achieve these and other objects, the present invention provides a system for holding together first and second objects, the system comprising: a first support connected to the first object; a second support connected to the second object; a third support removably positioned on the first and second supports and defining a first threaded opening therein; and a fastening member threadably positioned in the first opening and positioned with respect to the second object for enabling the fastening member to selectively hold the second object in fixed position with respect to the first object as the fastening member is rotated within the threaded opening.

It is to be understood that both the foregoing general description and the following detailed description are exemplary and explanatory but are not restrictive of the invention.

### BRIEF DESCRIPTION OF THE SEVERAL VIEWS OF THE DRAWINGS

The accompanying drawings, which are incorporated in and constitute a part of this specification, illustrate preferred embodiments of the invention and, together with the description, serve to explain the principles of the invention.

FIG. 1 is a fragmentary front elevation view of one invention embodiment;

FIG. 2 is a perspective view showing a portion of the embodiment illustrated in FIG. 1;

FIG. 3 is a perspective view of another portion of the invention embodiment illustrated in FIG. 1;

FIG. 4 is an elevation view showing a fastening member used in the embodiment shown in FIG. 1;

FIG. 5 is another perspective view of the structure illustrated in FIG. 2;

FIG. 6 is a perspective view of another invention embodiment;

FIG. 7 is a plan view showing use of the structure illustrated in FIG. 6 in another invention embodiment configuration;

FIG. 8 is another perspective view of the structure shown in FIG. 3;

FIG. 9 is another perspective view of a portion of the structure shown in FIGS. 2 and 5;

FIG. 10 is a fragmentary elevation view of another invention embodiment;

FIG. 11 is a perspective view of the invention embodiment shown in FIG. 10;

FIG. 12 is a perspective view of a portion of the invention embodiment shown in FIG. 11;

FIG. 13 is a perspective view of a portion of the invention embodiment illustrated in FIG. 11;

FIG. 14 is a perspective view of another invention embodiment;

FIG. 15 is a perspective view of still another invention embodiment;

FIG. 16 is a perspective view showing another configuration of the embodiment shown in FIG. 15;

FIG. 17 is a perspective view of a portion of the invention embodiments shown in FIGS. 15 and 16;

FIG. 18 is a plan view showing a portion of the embodiments shown in FIGS. 15 and 16;

FIG. 19 is a fragmentary perspective view showing the invention embodiments of FIGS. 15, and 16;

FIG. 20 is a perspective view of still another invention embodiment;

FIG. 21 is a perspective view of another configuration of the invention embodiment shown in FIG. 20;

FIG. 22 is a fragmentary perspective view showing the invention embodiments of FIGS. 20 and 21;

FIG. 23 is a fragmentary elevation view of still another invention embodiment;

FIG. 24 is a perspective view of the invention embodiment shown in FIG. 23;

FIG. 25 is an elevation view showing use of a portion of still another invention embodiment;

FIG. 26 is a perspective view showing that portion of the invention embodiment shown in FIG. 25;

FIG. 27 is a perspective view of still another invention embodiment;

FIG. 28 is a perspective view of another configuration of the invention embodiment shown in FIG. 27;

FIG. 29 is a side elevation view of a support used in the invention embodiments illustrated in FIGS. 27 and 28; and

FIG. 30 is a perspective view showing the invention embodiments illustrated in FIGS. 27 and 28.

### DETAILED DESCRIPTION OF THE INVENTION

With reference now to the drawings, wherein like reference characters designate like or corresponding parts throughout the several views, there is shown a system for holding together first 30 and second 32 objects. As illustrated herein by way of example, first object 30 is an open-front electrical panelboard box 34, and second object 32 is a cover 36 for box 34. It should be understood, however, that the systems and methods of this invention are applicable to many other situations where it is desired to firmly hold together first and second objects.

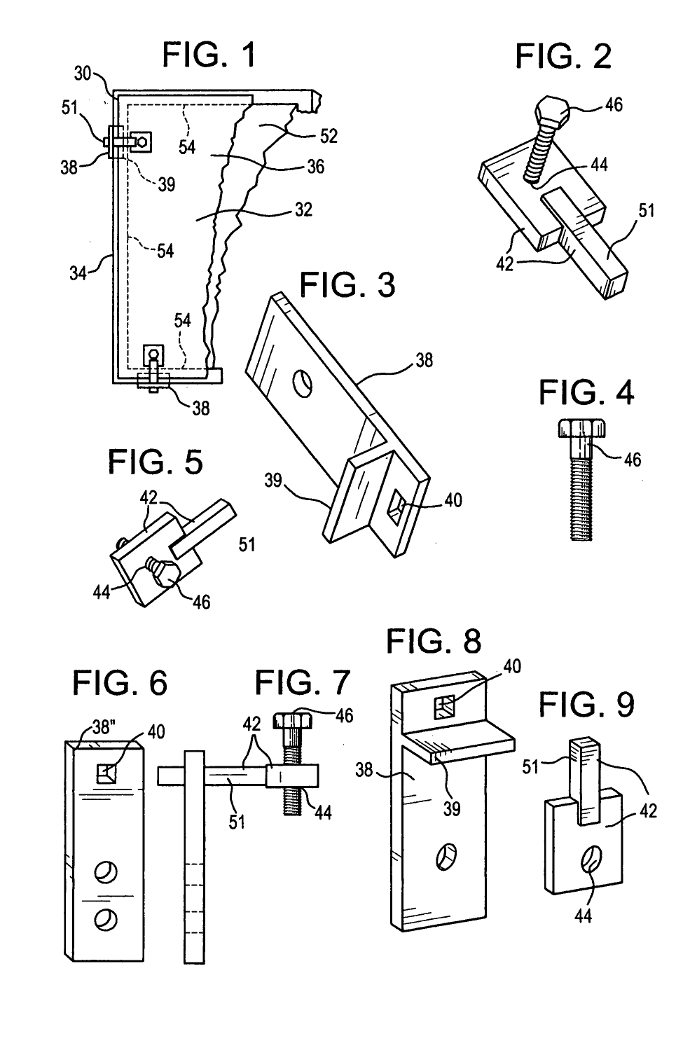

In accordance with the invention as shown in FIGS. 1-14, a first support or bracket 38 is conventionally connected to and projects from first object 30, and first support 38 defines at least a first opening 40 therein.

Second object 32 is positioned adjacent to first object 30, to first support 38 and to first opening 40. A first fastening member 42 is removably positioned in first opening 40 and defines a second, threaded opening 44 therein.

A second fastening member 46 is threadably positioned within second threaded opening 44 and is positioned with respect to second object 32 for enabling second fastening member 46 to selectively hold second object 32 in fixed position with respect to first object 30 as second fastening member 46 is rotated within second threaded opening 44.

In a first embodiment of this system, first opening 40 is non-circular, as shown in FIGS. 3, 6 and 8. In a second embodiment of this system, first opening 40′ is a slot 48, as shown in FIGS. 12 and 14.

First fastening member 42 includes a key element 51 removably positionable in first opening 40. Key element 51 is also non-circular in cross-sectional configuration to fit within first opening 40 so that key element 51 cannot rotate within first opening 40.

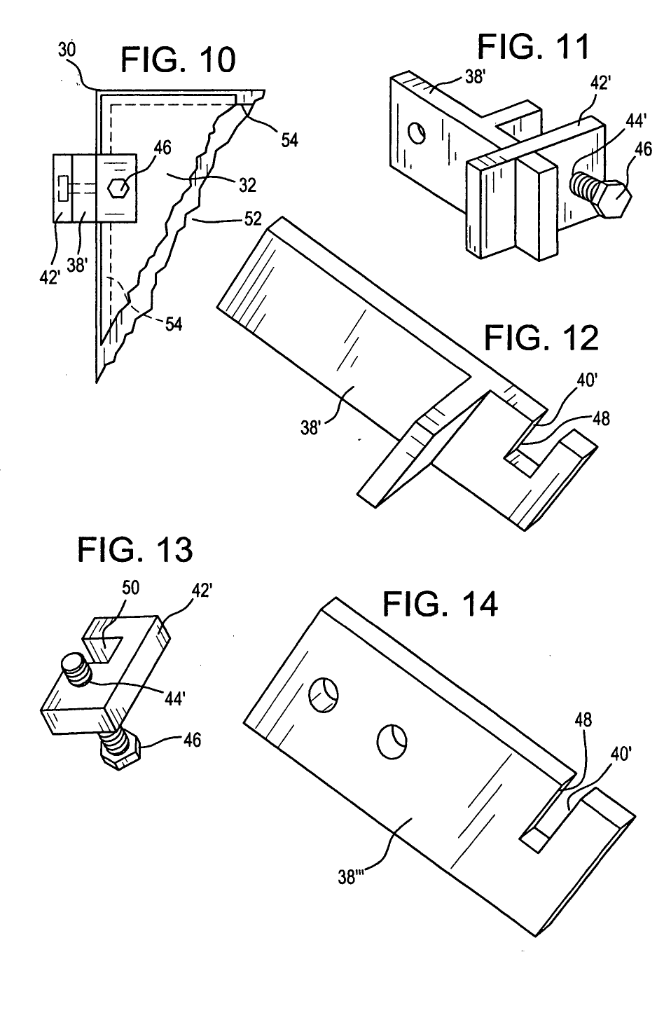

In the embodiment of this system shown in FIGS. 10-14, first opening 40′ is a first, open-ended slot 48, and first fastening member 42′ defines a second, open-ended slot 50 removably positionable within first slot 48.

Box 34 defines an open front 52 having a flange 54 extending into open front 52 substantially around the perimeter of open front 52, and cover 36 is preferably sized to substantially cover open front 52.

In first embodiments of this system, first support 38, 38′ is substantially T-shaped, as shown in FIGS. 3, 8 and 12. In second embodiments of this system, first support 38″, 38′″ is substantially straight and flat, as shown in FIGS. 6 and 14.

In operation and use of the system shown in FIGS. 1-9, first support or bracket 38 is conventionally attached to sides and the bottom of first object 30 or panelboard box 34 using machine screws (not shown) and/or by welding. Cover 36 is then positioned onto first support or bracket 38 which is connected to the bottom of box 34. Cover 36 is then positioned in contacting relationship with respect to T-portion 39 of first support or bracket 38. Key element 51 is then inserted into first opening 40 so that key element 51 extends through opening 40. Second fastening member or bolt 46 is threadably positioned through second threaded opening 44, and bolt 46 is tightened to engage cover 36 and to hold cover 36 in fixed position against T-portion 39.

To maintain correct positioning and spacing of cover 36 with respect to box 34, T-shaped supports or brackets 38 should be attached to the sides and bottom of box 34. This will ensure that panel cover 36 is equal distance from flange 54 as cover 36 is positioned against T-portions 39 of supports or brackets 38.

Likewise, if straight or flat supports or brackets 38″ are used, they should be connected to the sides and bottom of box 34 so that cover 36 is properly aligned and spaced with respect to box 34 and cover 36 will be positioned against flange 54 of box 34.

Alternatively, when T-shaped supports or brackets 38 are used, S-shaped supports, as described and illustrated in FIG. 12 of prior application Ser. No. 10/762,774, filed Jan. 23, 2004, could be used to support cover 36 instead of connecting supports or brackets 38 to the bottom of panelboard box 34. FIG. 12 of prior application Ser. No. 10/762,774, filed Jan. 23, 2004 and portions of that application describing FIG. 12 are hereby incorporated herein by reference as provided for by Manual of Patent Examining Procedure Section 608.01(p).

Alternatively, if straight or flat supports or brackets 38″ are selected for connecting to the sides of panelboard box 34, L-shaped supports can be attached to the bottom of panelboard box 34 instead of supports or brackets 38″. Such L-shaped supports are illustrated in FIG. 13 of prior application Ser. No. 10/762,774, filed Jan. 23, 2004, and FIG. 13 and the description of the L-shaped bracket illustrated in FIG. 13 in that application are hereby incorporated herein by reference, as provided for by Manual of Patent Examining Procedure Section 608.01(p).

By use of the system described above, panelboard box 34 and cover 36 are held in electrically grounding and contacting relationship with each other by second fastening members or bolts 46.

Alternative embodiments of the system described above are shown in FIGS. 10-14 wherein first opening 40′ is a first open-ended slot 48 and wherein second open-ended slot 50 can be removably positioned within first slot 48. In this embodiment, fastening member 42′ further defines a threaded opening 44′ therein, and second fastening member or bolt 46 is threadably positioned within threaded opening 44′ to contact cover 36 and to hold cover 36 in fixed position with respect to panelboard box 34, as described above. Fastening member 42′ can be used with T-shaped support or bracket 38′ or with straight or flat support or bracket 38′″.

To change fastening member 42′ from right or left hand operation, bolt 46 is removed from fastening member 42′ and rethreaded into opening 44′ in the opposite direction.

In order to maintain correct spacing between cover 36 and box 34, T-shaped supports or brackets 38′ should be connected to both the sides and bottom of box 34. Likewise, if straight or flat supports or brackets 38′″ are selected to be connected to the sides of box 34, a similar device that enables cover 36 to be positioned against flange 54 of box 34 should be connected to the bottom of box 34. An L-shaped bracket, for example, as shown in FIG. 13 of prior application Ser. No. 10/762,774, filed Jan. 23, 2004 could be connected to the bottom of box 34 when flat or straight supports or brackets 38′″ are connected to the sides of box 34.

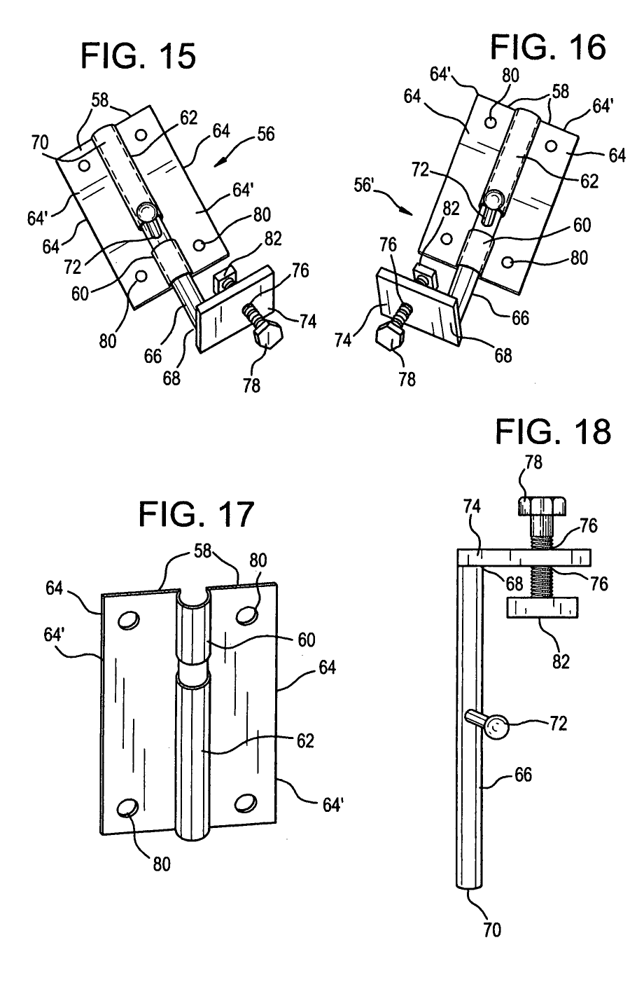

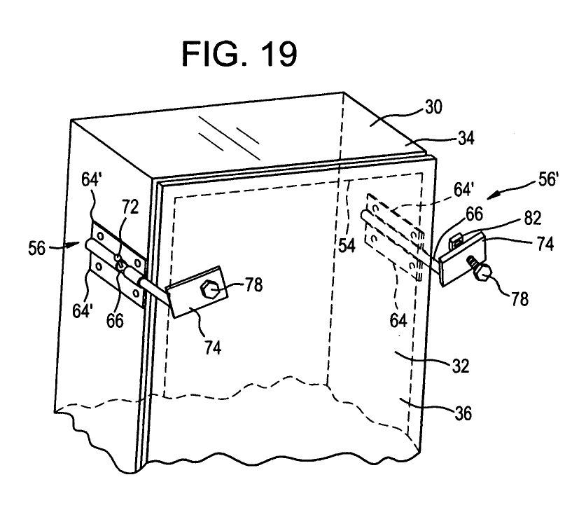

Another embodiment of this invention is shown in FIGS. 15-19 wherein assemblies 56, 56′ for holding together first 30 and second 32 objects are shown. Assembly 56 includes a first support 58 for conventionally connecting to first object 30, such as by machine screws (not shown) and/or by welding. Support 58 includes first and second axially aligned and spaced-apart, hollow substantially cylindrical members 60, 62. First support 58 includes a first member 64 connected to cylindrical members 60, 62 for conventionally connecting to first object 30.

Assembly 56 further includes a shaft 66, defining first and second ends 68, 70, movably positioned within cylindrical members 60, 62 with first end 68 extending outwardly beyond first cylindrical member 60.

A stop member 72 is connected to shaft 66 and is positioned between cylindrical members 60, 62. Stop member 72 extends outwardly from shaft 66 beyond cylindrical members 60, 62 for selectively contacting first member 64 and for enabling substantially 180° rotational movement of shaft 66 within cylindrical members 60, 62. Stop member 72 is conventionally welded, pressed, threaded or otherwise connected to shaft 66.

A second member 74 is connected to first end 68 of shaft 66, and second member 74 defines a threaded opening 76 therein. A threaded member or bolt 78 threadably engages threaded opening 76 for selectively holding second object 32 in fixed position with respect to first object 30.

First member 64 includes a substantially flat element 64′ which preferably defines openings 80 therein for conventionally connecting to first object 30 by machine screws (not shown).

Second member 74 is conventionally connected to shaft 66 to be positioned at substantially right angles with respect to flat element 64′ when stop member 72 is in contacting relationship with flat element 64′ and when second member 74 has rotated to first and second positions that are substantially 180° apart from each other. Assemblies 56, 56′ are identical to each other except for the orientations of stop members 72 with respect to shafts 66 to enable operative rotation of second members 74 between the first and second positions.

A foot element 82 is preferably conventionally connected to threaded member or bolt 78 for selectively contacting second object 32.

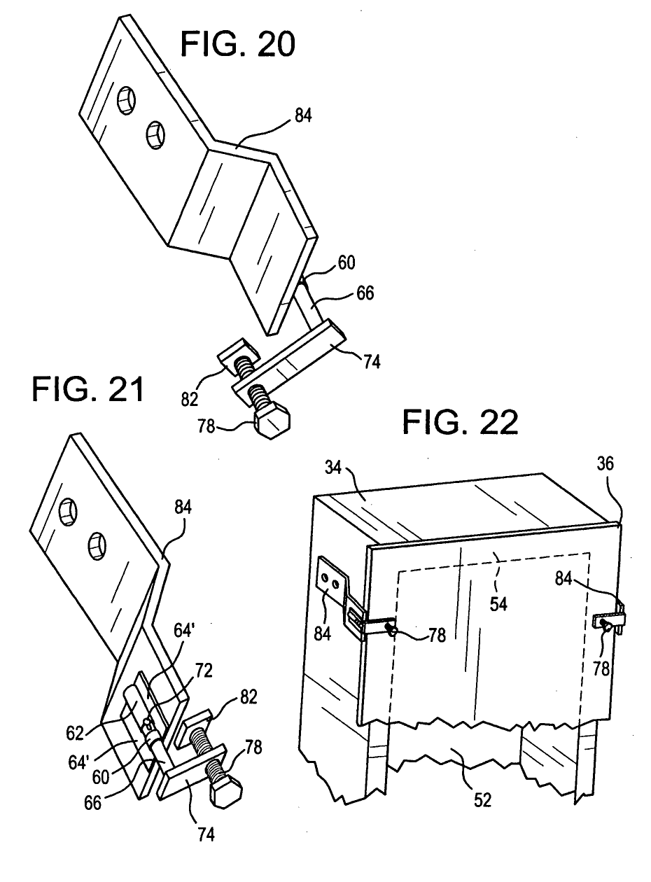

Another embodiment utilizing assembly 56 is illustrated in FIGS. 20-22 wherein a substantially Z-shaped support 84 is conventionally connected to flat element 64′ and wherein first support 84 is conventionally connected to first object 30. This embodiment is used when second object 32 or cover 36 is wider and/or longer than first object 30 or panelboard box 34.

In operation and use of the embodiments shown in FIGS. 15-19, flat element 64′ is conventionally connected to the sides of box 34 by welding and/or by using machine screws (not shown). Additional flat elements 64′ can be conventionally connected to the bottom of box 34, or other bottom brackets may be used. Panel cover 36 is placed onto the bottom brackets and is positioned in contact with flange 54 of box 34. Second member 74 and shaft 66 are then rotated within cylindrical members 60, 62 until stop member 72 engages flat element 64′ when second member 74 is positioned in front of cover 36. Threaded member or bolt 78 is then rotated within threaded opening 76 so that foot element 82 comes into contact with cover 36 to hold cover 36 in fixed position with respect to box 34 and against flange 54.

When it is desired to remove cover 36, the process described above is reversed and second member 74 is rotated in the opposite direction until stop member 72 contacts the other side of flat element 64′. Second member 74 is thus positioned out of the way so as to permit cover 36 to be removed.

As previously described herein with respect to other invention embodiments, L-shaped supports or brackets, as shown in FIG. 13 of prior application No. 10/762,774, can be conventionally connected to the bottom of box 34, and cover 36 can be positioned on those L-shaped supports or brackets.

The embodiment of the invention illustrated in FIGS. 20-22, wherein assembly 56 is connected to substantially Z-shaped support 84 is used where cover 36 is wider and/or longer than open front 52 of box 34. In this embodiment, substantially Z-shaped supports 84 are conventionally connected to flat elements 64′ and Z-shaped supports 84 are conventionally connected to the sides and/or bottom of box 34. The operation of assembly 56 in this embodiment is the same as that previously described.

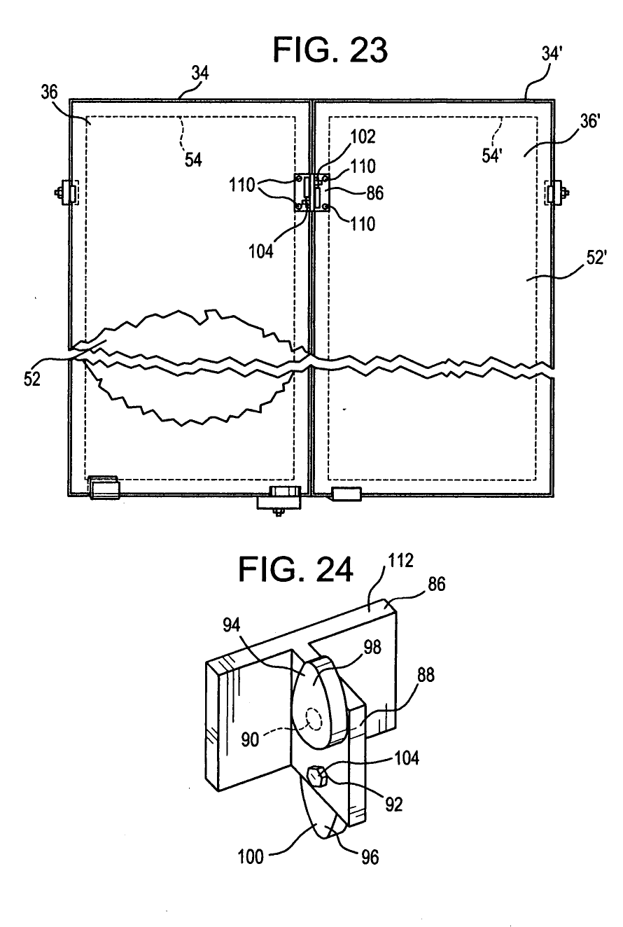

Additional invention embodiments are shown in FIGS. 23-24 wherein two or more panelboard boxes 34, 34′ are positioned in side-by-side abutting relationship with respect to each other. As previously described, open-front boxes 34, 34′ each includes a flange 54, 54′, respectively, extending into open fronts 52, 52′ and substantially around the perimeters of open fronts 52, 52′. Covers 36, 36′ as previously described, are sized to substantially cover open fronts 52, 52′.

This invention embodiment includes a first substantially T-shaped support 86 conventionally connected to and projecting outwardly from flanges 54, 54′. T-shaped support 86 includes a projecting member 88 positioned substantially perpendicularly with respect to flanges 54, 54′. Projecting member 88 defines first and second openings 90, 92, therein, and first and second fastening members 94, 96 are movably positioned within openings 90, 92, respectively. Covers 36, 36′ are respectively positioned over open fronts 52, 52′ and between T-shaped support 86 and fastening members 94, 96. Fastening members 94, 96 are then adjusted to hold covers 36, 36′ in fixed positions with respect to boxes 34, 34′, respectively.

In one embodiment shown in FIGS. 23-24, fastening members 94, 96 include first and second eccentric headed bolts 98, 100 movably positioned within openings 90, 92, respectively, and first and second nuts 102, 104 are adjustably connected to bolts 98, 100, respectively, for holding the bolts in positions within openings 90, 92.

Eccentric headed bolts 98, 100 are preferably the bolts illustrated in FIGS. 7 and 8 of prior application Ser. No. 10/762,774, filed Jan. 23, 2004 and FIGS. 7 and 8 of that application and the associated descriptive materials in that application are hereby incorporated by reference herein as provided for by Manual of Patent Examining Procedure Section 608.01(p).

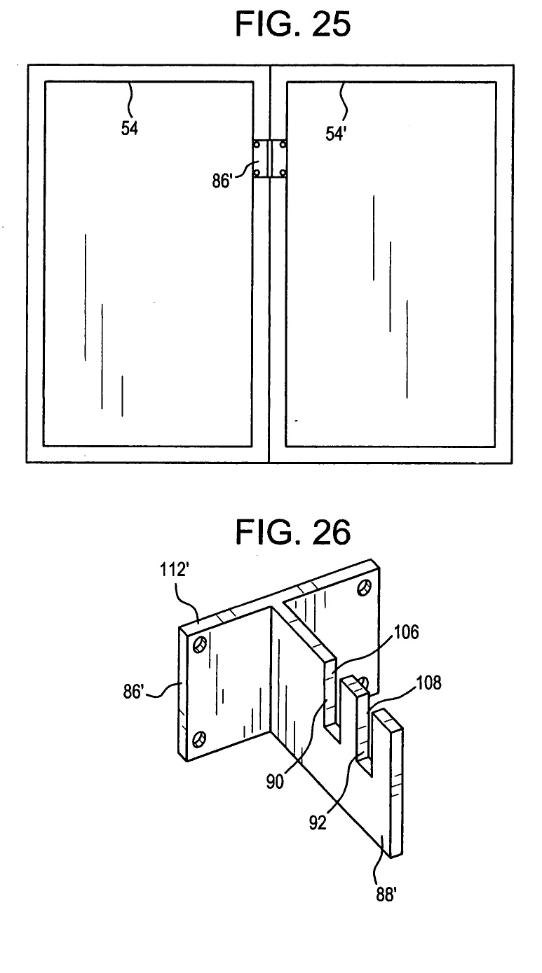

In a further embodiment shown in FIGS. 25-26, T-shaped support 86′ includes a projecting member 88′, and openings 90, 92 are first and second open-ended slots 106, 108, respectively.

Two fastening members 42′ (FIG. 13) are positioned with slots 50 within slots 106, 108, respectively. Fastening members 42′ have threaded bolts 46 threadably positioned within threaded openings 44′, and bolts 46 are rotated within threaded openings 44′ so that bolts 46 contact covers 36, 36′ and hold the covers in fixed position with respect to boxes 34, 34′, respectively.

In operation and use of the embodiments shown in FIGS. 23-26, T-shaped supports 86 or 86′ are conventionally connected to flanges 54, 54′ where those flanges are positioned adjacent to each other. Supports 86, 86′ are conventionally connected to flanges 54, 54′ by use of machine screws 110 and/or by welding.

Because the thickness of elements 112, 112′ of supports 86, 86′ causes covers 36, 36 to be spaced-apart from flanges 54, 54′, T-shaped supports or brackets as shown in FIG. 9 of prior application Ser. No. 10/762,774 should be installed on the sides of boxes 34, 34′ and on the bottoms of boxes 34, 34′. FIG. 9 and the associated descriptive material relating to FIG. 9 of prior application Ser. No. 10/762,774, filed Jan. 23, 2004 are hereby incorporated herein by reference as provided by Manual of Patent Examining Procedure Section 608.01(p).

Alternatively, S-shaped supports as shown in FIG. 12 of prior application Ser. No. 10/762,774, filed Jan. 23, 2004 can be positioned over bottom portions of flanges 54, 54′ in the manner described in prior application Ser. No. 10/762,774, and FIG. 12 of that application and the associated descriptive materials therein are hereby incorporated herein by reference as provided by Manual of Patent Examining Procedure Section 608.01(p).

When T-shaped support 86 is used, covers 36, 36′ are positioned onto the S-shaped supports shown in FIG. 12 of prior application Ser. No. 10/762,774 and against element 112 of T-shaped support 86. Eccentric headed bolts 98, 100 are then rotated within openings 90, 92, respectively, to contact covers 36, 36′ and to hold covers 36, 36′ in fixed positions with respect to boxes 34, 34′ when nuts 102, 104 are tightened onto eccentric headed bolts 98, 100.

When T-shaped supports 86′ are used, the procedure is identical to that previously described with respect to T-shaped supports 86 except that two fastening members 42′ are positioned with slots 5 0 respectively located within slots 106, 108. Bolts 46 are then tightened within threaded openings 44′ so that bolts 46 contact covers 36, 36′ to hold the covers in fixed positions with respect to boxes 34, 34′.

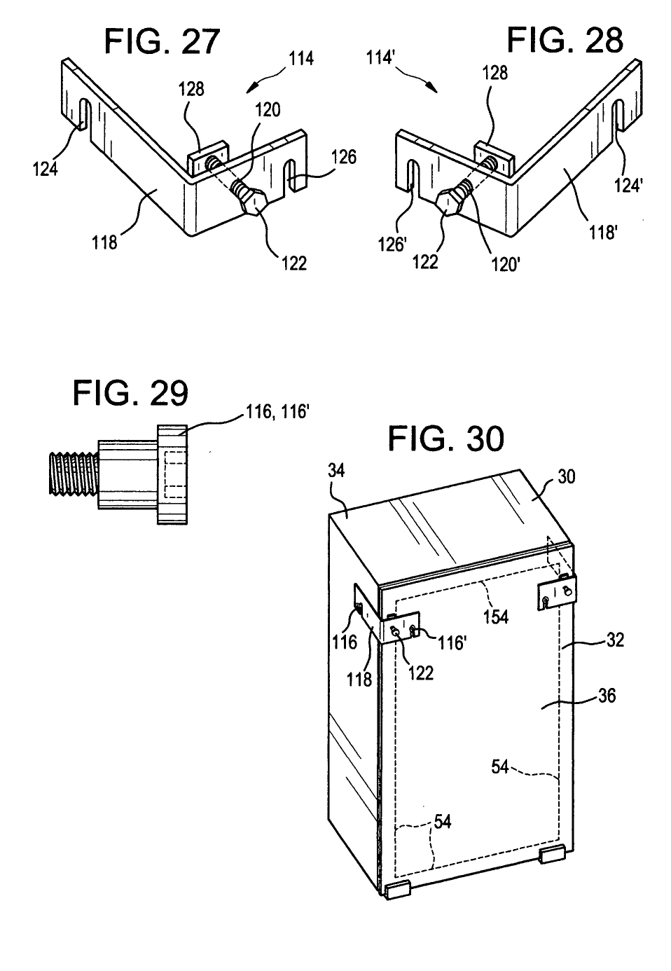

Another system embodiment 114 for holding together first 30 and second 32 objects is shown in FIGS. 27-30. System 114 includes a first support 116 connected to first object 30 or panelboard box 34. A second support 116′ is connected to second object 32 or cover 36. Supports 116, 116′ are preferably conventional shoulder screws.

A third support 118 is removably positioned on supports 116, 116′, and support 118 defines a first threaded opening 120 therein.

A fastening member or threaded bolt 122 is threadably positioned in opening 120 and is positioned with respect to second object 32 or cover 36 for enabling fastening member 122 to selectively hold second object 32 or cover 36 in fixed position with respect to first object 30 or panelboard box 34 as fastening member 122 is rotated within threaded opening 120.

Third support 118 is in the form of a substantially right angle, and third support 118 further defines second and third openings 124, 126 therein for removably positioning through and onto supports 116, 116′, respectively. Openings 124, 126 are open-ended slots.

A foot member 128 is preferably conventionally connected to fastening member or bolt 122 for contacting second object 32 or cover 36.

FIG. 27 illustrates a right-angle support 118 for positioning on first sides of objects 30, 32, and FIG. 28 shows a similar right-angle support 118′ for positioning on second sides of objects 30, 32. Systems 114, 114′ are identical in structure and operation with respect to each other except that system 114 is used on first sides of objects 30, 32 and system 1141 is used on second sides of objects 30, 32.

In operation and use of the embodiment shown in FIGS. 27-30, L-shaped supports or brackets, as shown in FIG. 13 of prior application Ser. No. 10/762,774, are conventionally connected to the bottom of box 34, and cover 36 is positioned on those L-shaped supports or brackets. Cover 36 is then moved toward panelboard box 34 so that cover 36 contacts flange 54 of box 34. Shoulder screws 116, 116′ have previously been connected to box 34 and cover 36, respectively, and right-angle support 118 is then positioned onto screws 116, 116′ by positioning the screws within slots 124, 126, respectively.

Fastening member or threaded bolt 122 is then turned within threaded opening 120 to move foot member 128 against cover 36 and to hold cover 36 in fixed position with respect to box 34 and against flange 54.

System 114′ is installed on the opposite sides of objects 30, 32 and operates in an identical manner to that described above with respect to installation of system 114.

In each of the embodiments described herein, the supports can be positioned to bypass existing electrical knockout locations at tops, sides or bottoms of electrical panelboard boxes and enclosures. When the systems and embodiments described herein are used on electrical panelboard boxes or enclosures that have other panel locking mechanisms, these other locking mechanisms must be removed and any openings created by that removal should be effectively closed to afford protection substantially equivalent to the walls of the panelboard box, according to National Electrical Article 110-12(a). For electrical panelboard boxes that require locking mechanisms, locking-style barrel bolts and brackets (not shown) can be used. Where panel covers are larger than existing panelboard boxes, the covers may require modification. Where panelboard boxes do not allow for drilling of holes through the boxes, supports can be installed by welding or other means. Additional supports in each of the embodiments described herein can be added where strength and/or tight fit is necessary. In addition, seals and sealing devices (not shown) can be added to provide dust and weather tight enclosure integrity.

The invention in its broader aspects is not limited to the specific details shown and described, and departures may be made from such details without departing from the principles of the invention and without sacrificing its chief advantages.

1. A system for holding together first (30) and second (32) objects, said system comprising:
a first support (38) connected to and projecting from said first object (30), said first support defining at least a first opening (40) therein;
said second object (32) positioned adjacent to said first object (30), to said first support (38) and to said first opening (40);
a first fastening member (42) positioned in said first opening (40) and defining a second, threaded opening (44) therein; and
a second fastening member (46) threadably positioned within said second threaded opening (44) and positioned with respect to said second object (32) for enabling said second fastening member (46) to selectively hold said second object (32) in fixed position with respect to said first object (30) as said second fastening member (46) is rotated within said second threaded opening (44).

2. A system as in claim 1 wherein said first opening (40) is non-circular.

3. A system as in claim 1 wherein said first opening (40′) is a first slot (48).

4. A system as in claim 1 wherein said first fastening member (42) includes a key element (51) removably positionable in said first opening (40).

5. A system as in claim 1 wherein said first opening (40′) is a first open-ended slot (48) and said first fastening member (42′) defines a second open-ended slot (50), said second slot (50) positionable within said first slot (48).

6. A system as in claim 1 wherein said first object (30) is an open-front box (34) and said second object (32) is a cover (36) for said box (34).

7. A system as in claim 6 wherein said box (34) defines an open front (52) having a flange (54) extending into said open front (52) substantially around the perimeter of said open front (52) and wherein said cover (36) is sized to substantially cover said open front (52).

8. A system as in claim 7 wherein said first support (38, 38′ is substantially T-shaped.

9. A system as in claim 7 wherein said first support (38″, 38′″) is substantially flat.

10. A system as in claim 6 wherein said box is an electric panelboard box (34) and wherein said box (34) and said cover (36) are held in electrically grounding contacting relationship with each other by said second fastening member (46).

11. A system as in claim 1 wherein said first fastening member (42) is removably positioned in said first opening (40).

12. A method for holding together first (30) and second (32) objects, said method comprising the steps of:
connecting a first support (38, 38′, 38″, 38′″) to and projecting from said first object (30), said first support (38, 38′, 38″, 38′″) defining at least a first opening (40, 40′) therein;
positioning said second object (32) adjacent to said first object (30), to said first support (38, 38′, 38″, 38′″) and to said first opening (40, 40′);
providing a first fastening member (42, 42′) defining a second threaded opening (44, 44′) therein;
removably positioning said first fastening member (42, 42′) in said first opening (40, 40′);
providing a second threaded fastening member (46); and
threadably positioning said second fastening member (46) within said second threaded opening (44, 44′) and with respect to said second object (32) for enabling said second fastening member (46) to selectively hold said second object (32) in fixed position with respect to said first object (30) as said second fastening member (46) is rotated within said second threaded opening (44, 44′).

13. An assembly (56) for holding together first (30) and second (32) objects, said assembly (56) comprising:
a first support (58) for connecting to said first object (30) and having first (60) and second (62) axially aligned and spaced-apart, hollow, substantially cylindrical members;
said first support (58) further having a first member (64) connected to said cylindrical members (60, 62) for connecting to said first object (30);
a shaft (66) defining first (68) and second (70) ends and movably positioned within said cylindrical members (60, 62) with said first end (68) extending outwardly beyond said first cylindrical member (60);
a stop member (72) connected to said shaft (66), positioned between said first (60) and second (62) cylindrical members and extending outwardly from said shaft (66) beyond said cylindrical members (60, 62) for selectively contacting said first member (64) and for enabling substantially 180° rotational movement of said shaft (66) within said cylindrical members (60, 62);
a second member (74) connected to said first end (68) of said shaft (66), said second member (74) defining a threaded opening (76) therein; and
a threaded member (78) threadably engaging said threaded opening (76) for selectively holding said second object (32) in fixed position with respect to said first object (30).

14. An assembly (56) as in claim 13 wherein said first member (64) includes a substantially flat element (64′).

15. An assembly (56) as in claim 14 wherein said second member (74) is connected to said shaft (66) to be positioned at substantially right angles with respect to said flat element (64′) when said stop member (72) is in contacting relationship with said flat element (64′) and when said second member (74) has rotated to first and second positions that are substantially 180° apart from each other.

16. An assembly (56) as in claim 15 further including a foot element (82) connected to said threaded member (78) for selectively contacting said second object (32).

17. An assembly (56) as in claim 16 further including a substantially Z-shaped support (84) connected to said flat element (64′) and for connecting said flat element (64′) to said first object (30).

18. In a system having at least two abutting open-front boxes (34, 34′) having first (54) and second (54′) flanges, respectively, extending into said open fronts (52, 52′) substantially around the perimeters of said open fronts (52, 52′) and having first (36) and second (36′) covers, respectively, sized to substantially cover the open fronts (52, 52′), the improvement comprising:
a first substantially T-shaped support (86) connected to and projecting outwardly from said first (54) and second (54′) flanges;
said T-shaped support (86) having a projecting member (88) positioned substantially perpendicularly with respect to said first (54) and second (54′) flanges;
said projecting member (88) defining first (90) and second (92) openings therein;
first (94) and second (96) fastening members positioned within said first (90) and second (92) openings, respectively; and
said covers (36, 36′) respectively positioned over said open fronts (52, 52′) and between said T-shaped support (86) and said fastening members (94, 96), whereby said fastening members (94, 96) hold said covers (36, 36′) in fixed positions over said open fronts (52, 52′).

19. The improvement of claim 18 wherein said fastening members (94, 96) include first (98) and second (100) eccentric headed bolts positioned within said openings (90, 92) and first (102) and second (104) nuts adjustably connected to said first (98) and second (100) bolts, respectively, for holding said bolts (98, 100) in position within said openings (90, 92).

20. The improvement of claim 18 wherein said first and second openings are first (106) and second (108) open-ended slots, respectively.

21. The improvement of claim 20 wherein said first (42′) and second (42′) fastening members define third (50) and fourth (50) open-ended slots, respectively, positionable within said first (42′) and second (42′) slots, respectively.

22. The improvement of claim 21 wherein said first (42′) and second (42′) fastening members further define first (44′) and second (44′) threaded openings, respectively, therein; and
first (46) and second (46) threaded bolts threadably positioned within said first (44′) and second (44′) threaded openings, respectively, and positioned with respect to said first (36) and second (36′) covers for enabling said bolts (46) to selectively hold said covers (36, 36′) in fixed positions with respect to said boxes (34, 34′) as said bolts (46) are rotated within said threaded openings (44′).

23. An assembly for holding together first (34, 34′) and second (36, 36′) objects, said assembly comprising:
a first substantially T-shaped support (86, 86′) for connecting to and projecting outwardly from said first objects (34, 34′);
said T-shaped support (86, 86′) having a projecting member (88, 88′) for positioning substantially perpendicularly with respect to predetermined portions (54, 54′) of said first objects (34, 34′);
said projecting member (88, 88′) defining first (90, 106) and second (92, 108) openings therein; and
first (94, 42′) and second (96, 42′) fastening members positioned within said first (90, 106) and second (92, 108) openings, respectively.

24. An assembly as in claim 23 wherein said fastening members include first (98) and second (100) eccentric headed bolts positioned within said openings (90, 92) and first (102) and second (104) nuts adjustably connected to said first (98) and second (100) bolts, respectively, for holding said bolts (98, 100) in position within said openings (90, 92).

25. An assembly as in claim 24 wherein said first and second openings are first (106) and second (108) open-ended slots, respectively.

26. An assembly as in claim 25 wherein said first and second fastening members (42′) define third (50) and fourth (50) open-ended slots, respectively, positionable within said first (106) and second (108) slots, respectively.

27. An assembly as in claim 26 wherein said first and second fastening members (42′) further define first and second threaded openings (44′), respectively, therein; and
first and second threaded bolts (46) threadably positioned within said first and second threaded openings (44′), respectively.

28. A system for holding together first (30) and second (32) objects, said system comprising:
a first support (116) connected to said first object (30);
a second support (116′) connected to said second object (32);
a third support (118) removably positioned on said first (116) and second (116′) supports and defining a first threaded opening (120) therein; and
a fastening member (122) threadably positioned in said first opening (120) and positioned with respect to said second object (32) for enabling said fastening member (122) to selectively hold said second object (32) in fixed position with respect to said first object (30) as said fastening member (122) is rotated within said threaded opening (120).

29. A system as in claim 28 wherein said third support (118) is in the form of a substantially right angle.

30. A system as in claim 29 wherein said third support (118) further defines second (124) and third (126) openings therein for removably positioning through and onto said first (116) and second (116′) supports, respectively.

31. A system as in claim 30 wherein said second and third openings are open-ended slots (124, 126).

32. A system as in claim 31 further including a foot member (128) connected to said fastening member (122) for contacting said second object (32).

33. A system as in claim 31 further including at least one additional support member connected to said first object (30) and supporting said second object (32).

34. An assembly (114) for holding together first (30) and second (32) objects, said assembly comprising:
a support (118) in the form of a substantially right angle and defining a first threaded opening (120) and second (124) and third (126) openings therein;
a fastening member (122) threadably positioned in said first threaded opening (120); and
said second (124) and third (126) openings being open-ended slots.
